(19) United States
(12) Patent Application Publication
(10) Pub. No.: US 2026/0156582 A1
(43) Pub. Date: Jun. 4, 2026

(54) MULTI-DIMENSIONAL MULTI-AP COORDINATION TECHNIQUE FOR DENSE DEPLOYMENTS OF WIRELESS NETWORKS

(71) Applicants: Huawei Technologies Canada Co., Ltd., Ottawa (CA); The University of Western Ontario, London (CA)

(72) Inventors: Zeyad Abdelmageid, Milton (CA); Xianbin Wang, London (CA); Osama Aboul-Magd, Ottawa (CA); Yan Xin, Ottawa (CA); Jung Hoon Suh, Ottawa (CA); Kwok Shum Au, Ottawa (CA)

(21) Appl. No.: 19/456,815

(22) Filed: Jan. 22, 2026

Related U.S. Application Data
(63) Continuation of application No. PCT/CA2023/050997, filed on Jul. 25, 2023.

(51) Int. Cl. H04W 52/24

(52) U.S. Cl. CPC H04W 52/241; H04W 52/242

(57) ABSTRACT

Provided herein is a method and system for managing multiple Access Points (APs) in a wireless network utilizing a multi-dimensional, cluster-based coordination scheme, known as a hybrid scheme. The hybrid scheme harmonizes the frequency and spatial domains to achieve consistent Signal-to-Interference Ratio (SIR) for all Main Access Points (M-AP) and Secondary Access Points (S-AP) Service Stations (STAs). In various implementations, the hybrid scheme may apply specific algorithms for coordinating the M-APs and S-APs.

### CROSS-REFERENCE TO RELATED APPLICATION

This application is a continuation of PCT Application No. PCT/CA2023/050997, entitled “MULTI-DIMENSIONAL MULTI-AP COORDINATION TECHNIQUE FOR DENSE DEPLOYMENTS OF WIRELESS NETWORKS,” filed on Jul. 25, 2023, which application is hereby incorporated herein by reference in its entirety.

### TECHNICAL FIELD

The disclosure generally pertains to the field of wireless networks, and in particular to a multi-dimensional, situation-aware coordination method for multi-Access Point (AP) networks of multiple APs.

### BACKGROUND

The IEEE 802.11 set of specifications, commonly known as Wi-Fi, is foundational to the operation of wireless network products, with clear channel assessment (CCA) sensing-based channel access introduced in the 802.11ac revision. CCA promotes efficient bandwidth use by allowing transmitters to send signals when the channel is idle, determined by the channel activity remaining below the CCA threshold.

However, due to increased network density, congestion and interference issues have arisen. A default CCA level of-82 dBm can cause access points (APs) to excessively defer accessing the channel in dense deployments, impacting throughput. Conversely, raising the CCA level improves channel utilization, enhancing spatial reuse and network throughput, but can lead to increased, unmanageable inter-BSS interference.

In response to these challenges, the IEEE 802.11ax introduced a spatial reuse scheme, which involves setting an overlapping basic service set packet detect (OBSS-PD) threshold, larger than the CCA threshold. This scheme permits an AP to sense the channel as idle even with channel activity larger than the CCA threshold, enabling it to gain access for transmission at a lower power, thereby limiting inter-BSS interference.

However, despite facilitating high spectral reuse, spatial reuse doesn't guarantee a minimum signal-to-interference ratio (SIR) across all stations (STAs) in a multi-AP network, due to the positional dependencies of spatial domain co-existence. Furthermore, the lack of direct AP communication in spatial reuse leads to coordination shortcomings, potentially degrading network performance. Therefore, there exists a need for reliable, situation-dependent, multi-AP coordination schemes that consider different domains of co-existence, that would alleviate the restrictions of the prior art.

This background information is provided to reveal information believed by the applicant to be of possible relevance to the present disclosure. No admission is necessarily intended, nor should it be construed that any of the preceding information constitutes prior art against the present disclosure.

### SUMMARY

The present disclosure aims to enhance the operation of ultra-dense network deployments. It introduces a method that ensures the minimum acceptable Signal-to-Interference Ratio (SIR) across all stations (STAs) in the network by incorporating coordination in both frequency and spatial domains. This mitigates the limitations of existing unidimensional schemes: Coordinated Spatial Reuse (CSR) and Coordinated Orthogonal Frequency Division Multiple Access (C-OFDMA), which are limited in managing inter-BSS interference in dense deployments.

As described herein, the main-AP (M-AP) assumes the role of determining the most appropriate coordination strategy for the given deployment scenario. This includes the M-AP securing a transmission opportunity (TXOP), which it can optionally share with secondary-APs (S-APs). Consequently, these APs can share the transmission medium across various domains, facilitating parallel transmissions while maintaining desired network reliability.

In accordance with an aspect of the present disclosure, there is provided a method for initiating multiple Access Point (multi-AP) communications in a wireless network. The method includes broadcasting a multi-AP coordination capability by an access point (AP). The multi-AP coordination capability is included in a broadcast frame. The AP further sends a trigger for a path loss report to a station (STA) associated with the AP. The AP receives a path loss report from the STA associated with the AP. The AP receives a second multi-AP capability of the second AP from a second AP. The AP adds the second AP to a list of multi-AP capable APs of the wireless network. The AP wins a transmission opportunity (TXOP) of a channel of the wireless network by the AP.

In embodiments, the broadcast frame is a beacon frame.

In embodiments, the AP receives the second multi-AP capability in a second broadcast frame.

In embodiments, the second broadcast frame is a second beacon frame.

In accordance with another aspect of the present disclosure, there is provided a method for organizing multiple Access Point (multi-AP) communications in a wireless network. The method includes determining, by a main Access Point (M-AP) a first path loss between a first station (STA) and the M-AP. The M-AP then sends to a secondary Access Point (S-AP), a request for a path loss report of a second STA associated with the S-AP. The M-AP receives the path loss report. The M-AP further groups at most two access points (APs) into a cluster, the at most two access points having a multi-AP capability. For each cluster, the M-AP evaluates a spatial configuration for both APs within the cluster. The method further includes adjusting a first transmit power level of the first AP in the cluster and adjusting a second transmit power level of the second AP. The first power level and the second power enable a Signal to Interference Ratio (SIR) of the first STA and of the second STA.

In embodiments, the adjusting of the first transmit power level and the adjusting of the second transmit power level includes adjusting the transmit power of the APs so that the SIR exceeds a minimum SIR.

In embodiments, the method further includes allocating, by the M-AP, non-overlapping portions of a channel of the wireless network to the clusters.

In embodiments, the at most two APs of the cluster are determined based on the path loss report.

In embodiments, the STA is one of a plurality of STAs most susceptible to interference from a third AP of the wireless network.

In embodiments, the third AP is one of the M-AP or the S-AP.

In embodiments, the cluster includes one or two multi-AP capable access points.

In accordance with another aspect of the present disclosure, there is provided an apparatus for organizing multiple Access Point (multi-AP) communications in a wireless network. The apparatus includes a processor and a tangible, non-transitory computer readable memory configured to perform a method as defined in any one of aforementioned methods.

In accordance with another aspect of the present disclosure, there is provided a system for organizing multiple Access Point (multi-AP) communications in a wireless network. The system includes one or more computers each including a processor and a tangible, non-transitory computer readable memory. The computer readable memory includes instructions recorded thereon to be performed by the one or more computers of the system to carry out a method as defined in any one of aforementioned methods.

In accordance with another aspect of the present disclosure, there is provided a tangible, non-transitory computer readable memory having instructions recorded thereon to be performed by at least one processor to carry out a method as defined in any one of aforementioned methods.

Embodiments of the present disclosure may provide technical advantages or benefits.

First, the situation aware, multi-dimensional design of the proposed scheme allows the leading AP to evaluate the inter-BSS interference conditions, develop both frequency and spatial domain coordination schemes, and specify the appropriate corresponding transmission parameters. As a result, the multi-AP network does not have to tolerate the limitations of a specific domain and, as a result, can offer higher degrees of reliability compared to existing CSR and C-OFDMA schemes.

Second, the proposed cluster-based scheme supports multi-AP coordination in ultra-dense deployments with a high number of APs unlike existing CSR and C-OFDMA schemes which support a limited number of APs.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which;

FIG. 1 illustrates the effect of deploying spatial reuse compared to traditional CCA sensing, according to an embodiment.

FIG. 2 illustrates the effect of the selected OBSS-PD threshold value on the transmission power, according to an embodiment.

FIG. 3 illustrates an example of spatial reuse in a multi-AP network, according to an embodiment.

FIG. 4 illustrates a scenario where spatial reuse fails to improve overall system performance, according to an embodiment.

FIG. 5 illustrates the message flow involved in the present disclosure, according to an embodiment.

FIG. 6 illustrates an application of the present disclosure, according to an embodiment.

FIG. 7 illustrates an application of the present disclosure, according to an embodiment.

FIG. 8 illustrates an example where the present disclosure is deployed within a cluster, and the spatial domain is the chosen domain of co-existence, according to an embodiment.

FIG. 9 illustrates an example where the present disclosure is deployed within a cluster, and the frequency domain is the chosen domain of co-existence, according to an embodiment.

FIG. 10 illustrates an example where the present disclosure is deployed amongst three APs, and the frequency and spatial domain are both deployed for co-existence, according to an embodiment.

FIG. 11 illustrates a flowchart which summarizes the overall present disclosure, according to an embodiment.

FIG. 12 illustrates a flowchart which summarizes the overall present disclosure within each cluster, according to an embodiment.

FIG. 13 illustrates the feedback process of intra-cluster coordination, according to an embodiment.

FIG. 14 illustrates a CSR frame exchange process, according to an embodiment.

FIG. 15 illustrates a scenario including three APs and three STAs, according to an embodiment.

FIG. 16 illustrates a process of intra-cluster coordination where the two solid red lines represent the region of solutions, and the dotted red line represents the midpoint taken as the solution, according to an embodiment.

FIG. 17 illustrates an electronic device, according to an embodiment, that may be used to implement any of the methods described herein.

It will be noted that throughout the appended drawings, like features are identified by like reference numerals.

### DETAILED DESCRIPTION

Access Point (AP), as used herein, refers to a networking hardware device that allows wireless devices to connect to a wired network using Wi-Fi or related standards. The AP usually connects to a router (via a wired network) as a standalone device, but it can also be an integral component of the router itself. It serves as a central transmitter and receiver of Wi-Fi radio signals. Main Access Point (M-AP), as used herein, refers to the primary AP in a multi-AP network environment that often coordinates network activities, sets transmission parameters, and generally holds the responsibility for ensuring network performance and integrity. M-AP typically manages interference and traffic loads by setting key network parameters and taking the lead in communication processes. Meanwhile, Secondary Access Point (S-AP), as used herein, refers to any other APs in a multi-AP network environment that function under the coordination of the M-AP. These S-APs follow the directives of the M-AP, adjusting their activities and parameters accordingly to aid in the overall network performance and stability. They usually provide additional network coverage and capacity, working in concert with the M-AP in accordance with a defined coordination strategy, such as a multi-dimensional, situation-aware coordination method, to enhance overall network performance. The M-AP is not a static role. Out of all APs, the AP which wins the TXOP and is willing to share it with neighboring APs becomes the M-AP throughout the TXOP window and other APs become S-AP.

Basic Service Set (BSS), as used herein, refers to a group of stations (i.e., computers or devices) that utilize a shared service set identifier (SSID). Device of a BSS share physical-layer medium access characteristics (e.g., radio frequency, modulation scheme, security settings, etc.) such that they may be wirelessly connected. A BSS can be an independent BSS (without an access point) or an infrastructure BSS (with an access point) where all stations communicate through a single access point.

Block Acknowledgment (BA), as used herein, refers to a method used in wireless communication for acknowledging a block of data frames received, instead of acknowledging each individual frame. In the context of Coordinated Spatial Reuse (CSR) and Coordinated Orthogonal Frequency-Division Multiple Access (C-OFDMA), BA contributes to efficiency by reducing the overhead of individual acknowledgments. CSR allows simultaneous transmissions in overlapping networks by intelligently managing interference, while C-OFDMA enables finer granularity resource allocation, allowing multiple users to share a single channel. Together, these methods optimize wireless transmission, making it more efficient and robust.

Clear Channel Assessment (CCA), as used herein, refers to a mechanism used in wireless communication to determine whether a radio channel is clear or occupied before transmission. It can help minimize collisions and improve overall network efficiency.

Coordinated Spatial Reuse (CSR), as used herein, refers to a strategy used in wireless networks to increase capacity and reduce interference. It involves the coordinated use of the same frequency band by different nodes in a network, located at a distance from each other, effectively reusing the frequency and maximizing network throughput.

Coordinated Orthogonal Frequency-Division Multiple Access (C-OFDMA), as used herein, refers to a coordination scheme where a channel is further divided into resource units (RUS) where each RU then allocated to each network thus mitigating interference between neighboring networks. This coordination allows for parallel data transmission from multiple, neighboring BSSs without interference.

Physical Layer (PHY), as used herein, refers to the first and lowest layer in the Open Systems Interconnection (OSI) model of computer networking. It's responsible for the transmission and reception of unstructured raw data streams over a physical medium. The PHY layer deals with the physical characteristics of the network, such as wiring, connectors, signal levels, and radio frequencies.

Media Access Control (MAC) layer, as used herein, refers to a sublayer of the Data Link layer in the OSI model. The MAC layer is responsible for managing how devices in a network gain access to data and permission to transmit it. It controls how devices use a shared medium, avoiding collisions and ensuring smooth network operation.

Overlapping Basic Service Set (OBSS), as used herein, refers to a scenario in wireless networking where multiple Basic Service Sets (BSS) intersect, and their corresponding Access Points (APs) are within each other's reach. Such circumstances can potentially cause interference, resulting in a degradation of network performance. This problem is particularly prevalent in the 2.4 GHz band, due to its restricted number of non-overlapping channels and due to the resulting longer transmission range.

Signal-to-Interference Ratio (SIR), as used herein, also known as the Signal-to-Noise Ratio (SNR), refers to a measure used in wireless communications to define the quality of a signal in relation to the level of interference. SIR is defined as a ratio of the received power of the desired signal to the received signal power of interfering signals. A higher SIR indicates a clearer signal and can result in better network performance and quality of service.

Resource Unit (RU), as used herein, refers to a division of the transmission spectrum into smaller units, used in wireless communication, particularly in Wi-Fi 6. Each channel can be segmented into several RUs, allowing multiple data transmissions to occur simultaneously using non-overlapping spectrum, thus improving network capacity. The size of an RU is dynamically adjustable based on connected devices' needs and network conditions. This enhances network performance and efficiency, especially in high-density environments.

Transmission Opportunity (TXOP), as used herein, refers to the period when a wireless station can transmit data on a shared communication medium. The TXOP concept is especially important in Wi-Fi networks, where it helps regulate when and for how long a station can send data to avoid collisions and ensure fair access.

Station (STA), as used herein, refers to a device in the context of wireless networks that has the capability to actively participate in network communication. This includes devices such as laptops, smartphones, tablets, and other devices that can transmit and receive data.

IEEE 802.11 standard, as used herein, includes a set of media physical layer (PHY) and access control (MAC) specifications for implementing Wireless Local Area Network (WLAN) communication, otherwise known as Wi-Fi, in unlicensed frequency bands (e.g., 2.4 GHz, 3.6 GHz, 5 GHZ, and 60 GHz). The IEEE 802.11 standard forms the basis for wireless network products that use Wi-Fi bands as a means of communication. The IEEE 802.11ac standard may include Clear Channel Assessment (CCA) sensing-based channel access methods, allowing a transmitter to send signals in a shared, common channel as long as the detected channel activity remains below the CCA threshold, or, in other words, when the channel is idle. This method promotes efficient use of system bandwidth resources.

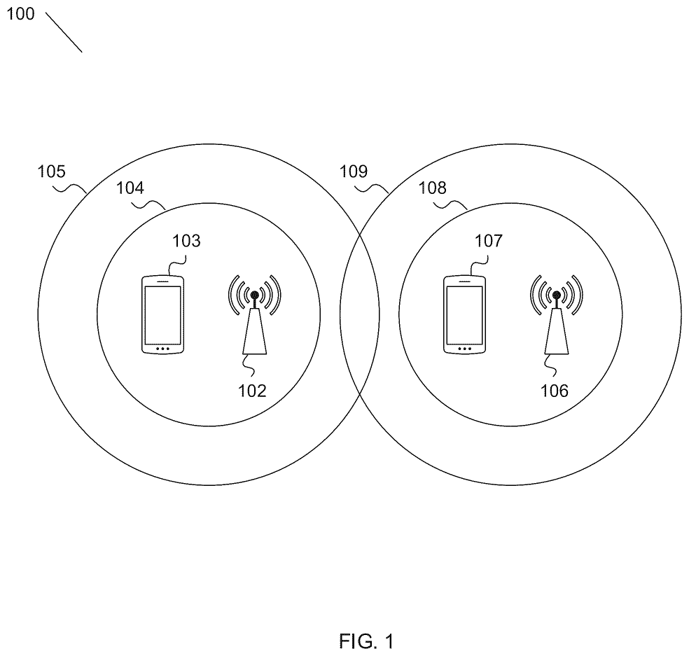

FIG. 1 illustrates the effect of deploying spatial reuse compared to traditional CCA sensing, according to an embodiment. Notably, Spatial Reuse (SR) allows an AP to set a threshold known as Overlapping Basic Service Set Packet Detect (OBSS-PD) which is larger than the CCA threshold. The OBSS-PD threshold's minimum and maximum values may be −82 dBm and −62 dBm respectively. As a result, an AP senses the channel as idle even if the detected channel activity is larger than the CCA threshold if it does not exceed the OBSS-PD threshold. AP 102 has a default CCA threshold 105 and a larger OBSS-PD threshold 104, and another AP 106 has a default CCA threshold 109 and a larger OBSS-PD threshold 108. Once either AP 102 or AP 106 gains access to the channel via the OBSS-PD threshold 104 or 108, that particular AP starts transmission at a lower power level, which helps to restrict the inter-BSS interference.

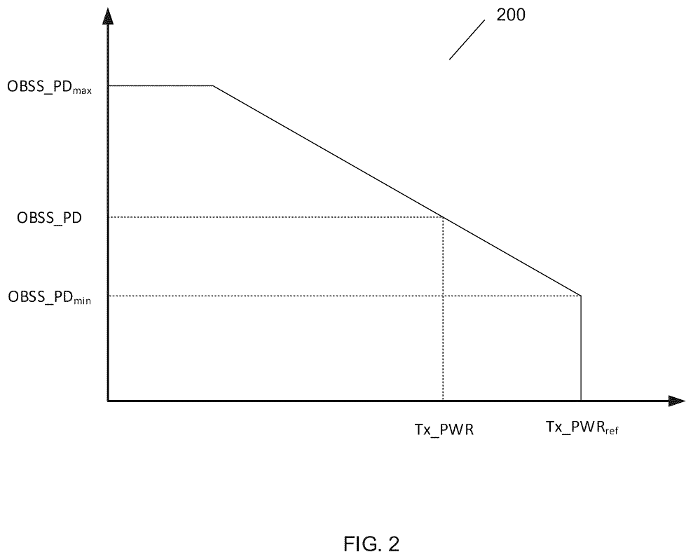

FIG. 2 illustrates the effect of the selected OBSS-PD threshold value on the transmission power, according to an embodiment. As illustrated, the transmission power (TX power) of an AP employing spatial reuse (SR) is adjusted based on the chosen OBSS-PD threshold value. This means that an increase in the OBSS-PD threshold results in a reduction in the TX power. In other words, the greater the channel activity which a device can disregard and consider idle, the lower the TX power will be. As a result, an AP that employs spatial reuse can access the channel, even when it would be considered busy under CCA, thus enhancing channel utilization. For example, the value of TX power can be expressed in a linear mathematical equation:

$$T {X}_{PWR} = T {X}_{{PWR}_{ref}} - ( O B S {S}_{PD} - O B S {S}_{{PD}_{min}} )$$

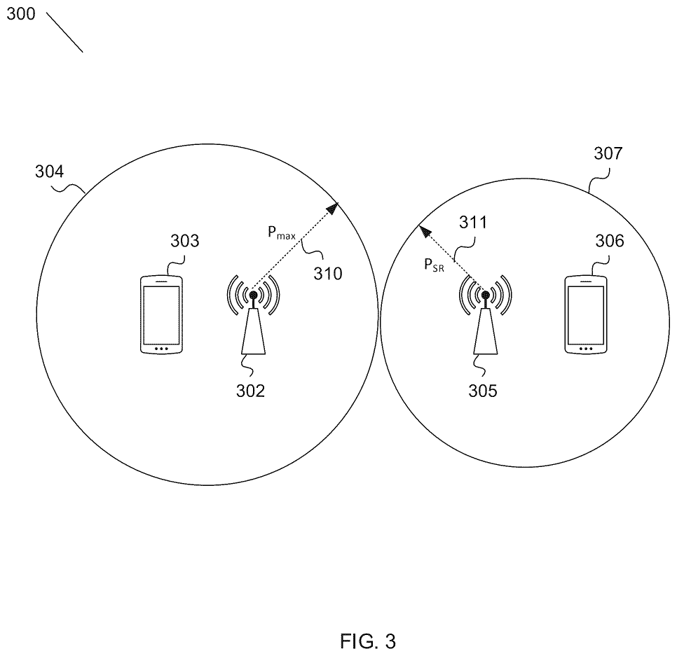

FIG. 3 illustrates an example of spatial reuse within a multi-AP network, according to an embodiment. AP 305 perceives the channel to be idle, despite AP 302 transmitting, due to the established OBSS-PD threshold 307 and transmits at a reduced transmission power (P_{SR}) 311, compared to AP 302 which transmits at its maximum or full power (Pₘₐₓ) 310.

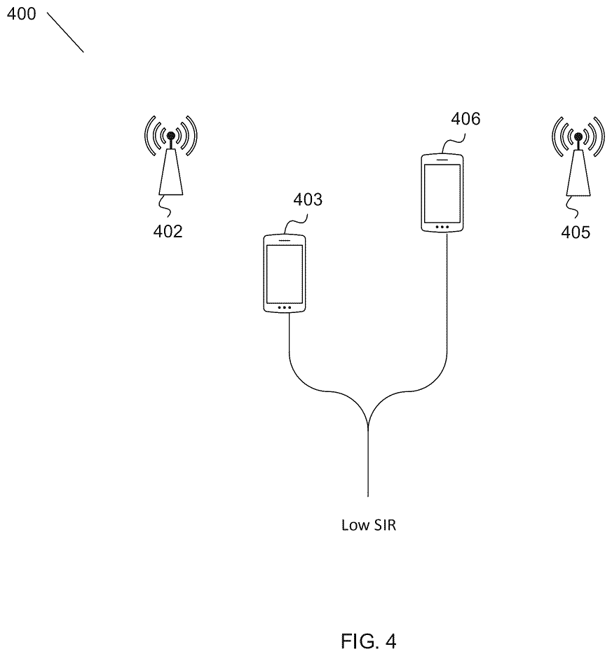

FIG. 4 illustrates a scenario where spatial reuse fails to improve overall system performance, according to an embodiment. Despite the high spectral reuse achieved by spatial reuse, it may not reliably ensure a minimum Signal-to-Interference Ratio (SIR) across stations (STAs) in a multi-Access Point (AP) network. For example, STA 403 and STA 406 experience extremely low SIR due to their position or location, even though AP 405 is transmitting with limited power. This is mainly due to the limitations of co-existence within the spatial domain, which is highly dependent on the positioning of devices. As a result, a STA may end up in a position or location where maintaining a satisfactory throughput through spatial co-existence, even with transmission power restrictions on nearby APs, is not feasible. Therefore, co-existence within the spatial domain may not always be suitable, and alternative domains should be explored depending on the specifics of the deployment scenario.

In addition, despite improvements in parallel transmissions, certain limitations still exist, which further degrade the overall performance of a network when spatial reuse is utilized. This may be due to a lack of direct communication between APs when using spatial reuse, leading to an absence of true coordination. Such lack of coordination among transmitters can degrade the signal to interference ratio (SIR) for OBSS receivers. In some scenarios, the degradation could result in performance worse than in CCA-based channel sensing scenarios.

For example, referring to FIG. 4, both STA 403 and STA 406 experience low SIR due to spatial reuse. On the other hand, CCA-based channel access could allow at least one of the STAs to experience adequate SIR. Therefore, there is a pressing need for a reliable, situation-dependent, multi-AP coordination scheme with a multi-dimensional design (also referred to as the “hybrid” scheme) which allows other domains of co-existence to be considered depending on the deployment scenario.

Embodiments utilize a feedback mechanism, included in Coordinated Spatial Reuse (CSR), between the master AP (M-AP) and the neighboring secondary AP (S-AP), facilitating the exchange of interference and path loss information between the APs. As a consequence, the M-AP determines the transmit power for the S-AP in such a manner that the STAs associated with the M-AP do not experience inter-Basic Service Set (BSS) interference beyond a tolerable threshold. This makes CSR particularly apt for deployments with low to intermediate levels of inter-BSS interference.

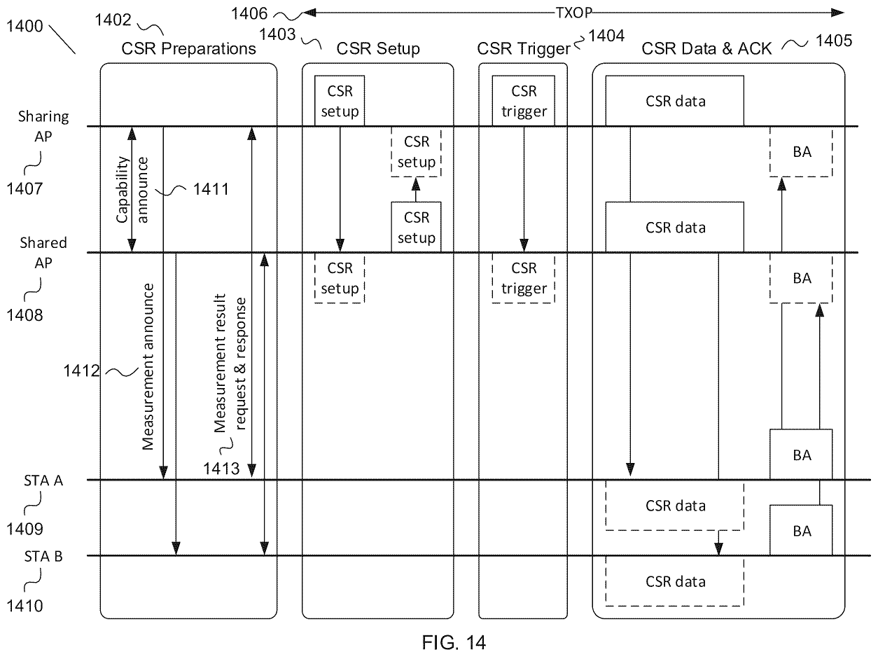

FIG. 14 illustrates a CSR frame exchange process, according to an embodiment. Generally, main AP (M-AP) calculates the Acceptable Receiver Interference Level (ARIL) at its STAs in order to maintain a minimum required SIR; M-AP calculates the maximum TX power of the secondary AP (S-AP) such that the interference experienced at the M-AP's STAs does not exceed the ARIL; M-AP transmits at maximum power; and M-AP communicates to the S-AP this information in the trigger frame to start CSR transmission.

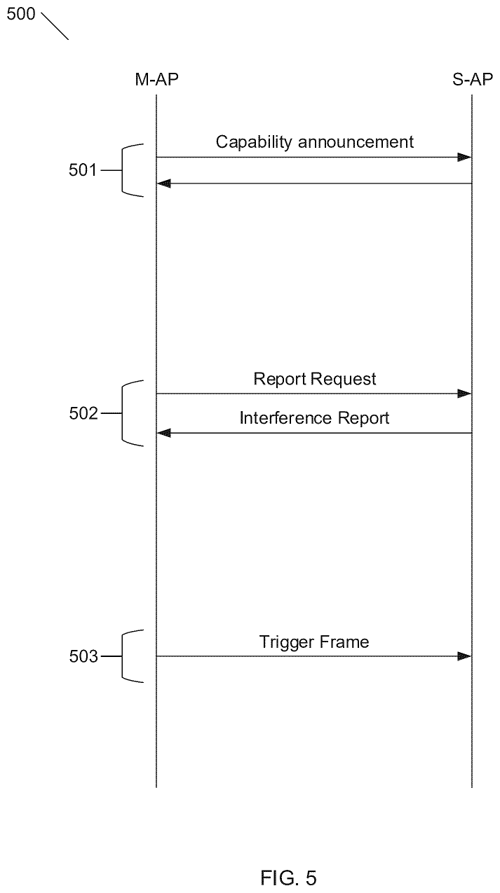

Referring to FIG. 14, multiple (shared) APs (e.g., AP 1407 and AP 1408) and multiple STAs (e.g., STA A 1409 and STA B 1410) are engaged in the process or steps of CSR preparation phase 1402, CSR setup (and clustering) phase 1403 and CSR trigger phase 1404 and CSR data and acknowledgement phase 1405 (similarly, aligned with preparation phase 501, set-up phase 502 and transmission phase 503 illustrated in FIG. 5). More information of the respective phases is described in a subsequent section of the present disclosure.

FIG. 5 illustrates a message flow involved in the present disclosure, according to an embodiment. Embodiments may include three main phases; a preparation phase 501, a set-up phase 502 and a transmission phase 503. For example, in the preparation phase 501, an M-AP sends a capability announcement request (e.g., multi-AP coordination capability) to a S-AP and accordingly, the S-AP sends back a response message to the M-AP. In set-up phase 502, the M-AP sends a report (e.g., path loss report) request to the S-AP and accordingly, the S-AP sends back an interference report to the M-AP. In the transmission phase 503, the M-AP sends a trigger frame to the S-AP. Another embodiment is described with reference to FIG. 14.

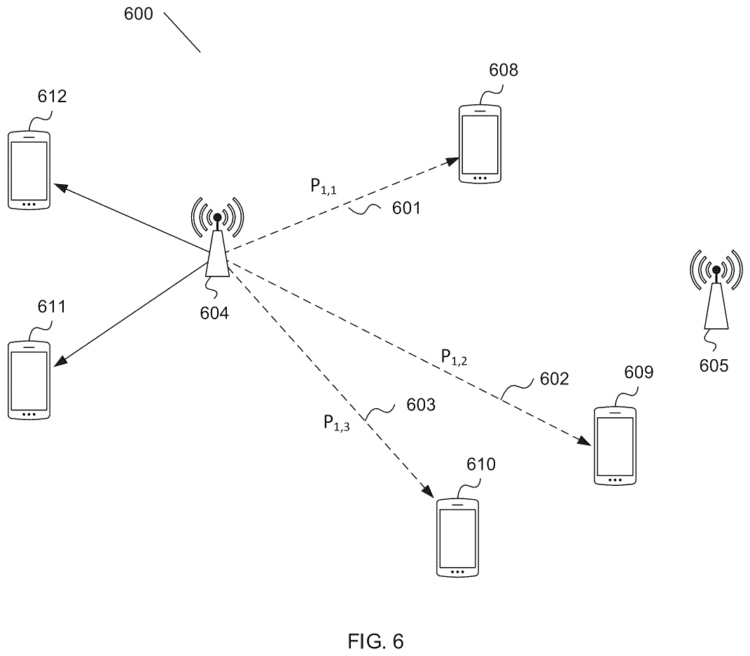

FIG. 6 illustrates an application (e.g., a cluster topology) of the present disclosure, according to an embodiment, though the present disclosure is not limited to cluster topologies. STA 608, STA 609 and STA 610 are associated with S-AP 605, and STA 611 and STA 612 are associated with M-AP 604. In addition, the dashed lines 601, 602 and 603 represent the path loss effect between the M-AP 604 and each respective STA (e.g., STA 608, STA 609 and STA 610). During the preparation phase, the S-AP requests path loss values (e.g., P_{1,1}, P_{1,2} and P_{1,3}) from its associated STAs (e.g., STA 608, STA 609 and STA 610). Afterwards, in the set-up phase, the S-AP 605 reports to the M-AP 604 the path loss value of the STA most susceptible to OBSS interference.

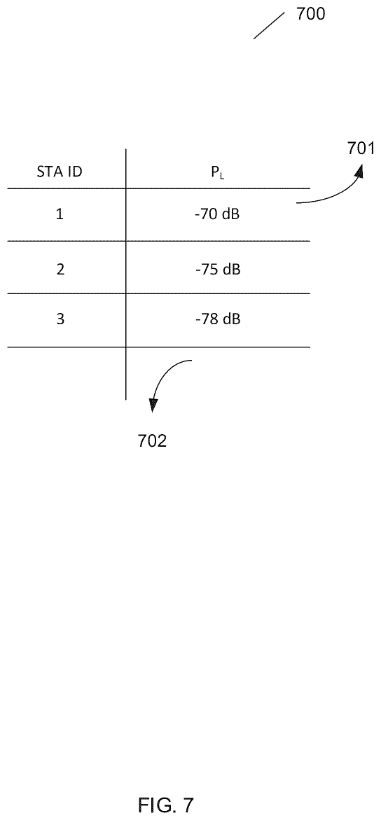

FIG. 7 illustrates an example of the path loss values, according to an embodiment. P_{L} represents the path loss value reported by a STA. For example, among STA 610, STA 609, and STA 608 in FIG. 6 are associated with S-AP 605, the STA most susceptible to OBSS interference is STA 608, then pathloss value measured at STA 608 is the lowest pathloss value (i.e., 701 denoting −70 dB in FIG. 7) which would be reported back to the M-AP 604 by the S-AP 605. Afterwards, the M-AP 604 selects the domain of co-existence. Thus, in FIG. 7, 701 having the value of −70 dB represents the lowest path loss, corresponding to the highest interference signal strength, while 702 having the value of −78 dB signal has the highest path loss, indicating the weakest interference signal strength.

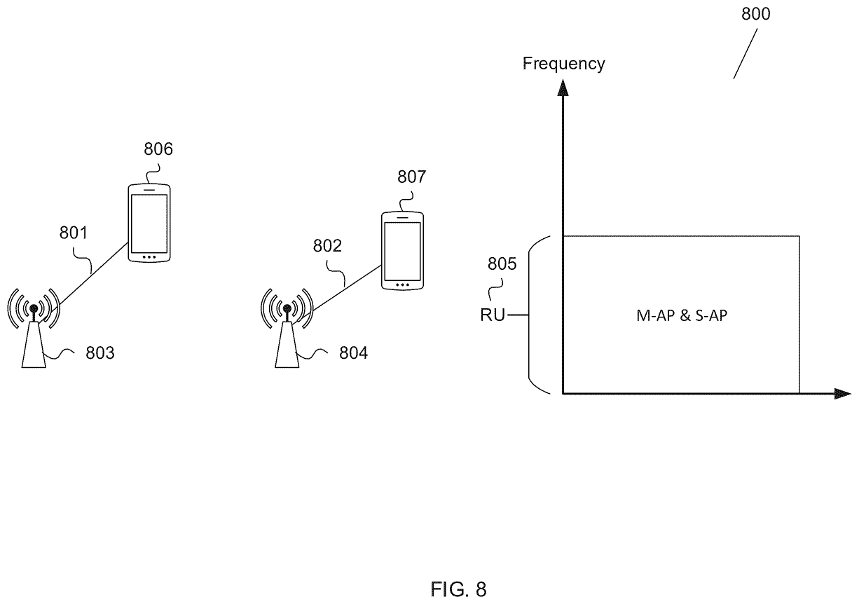

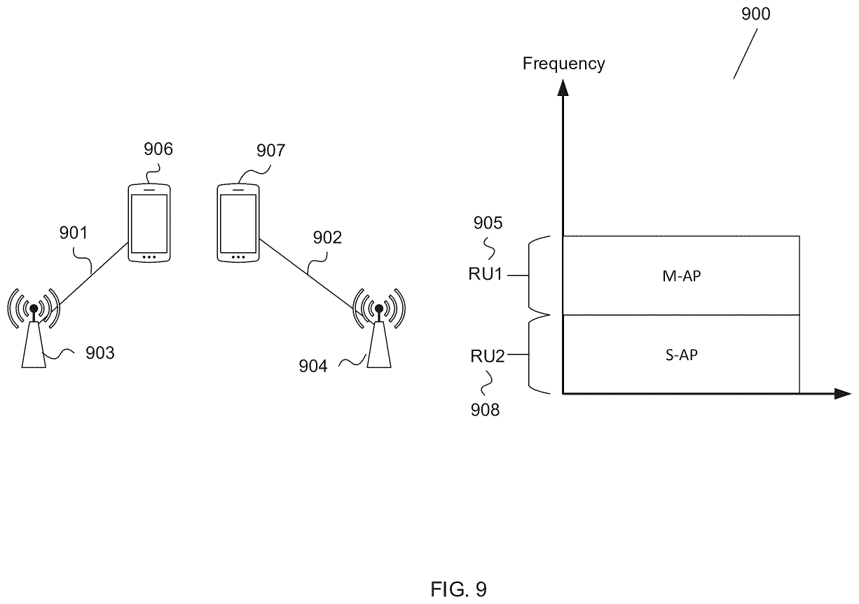

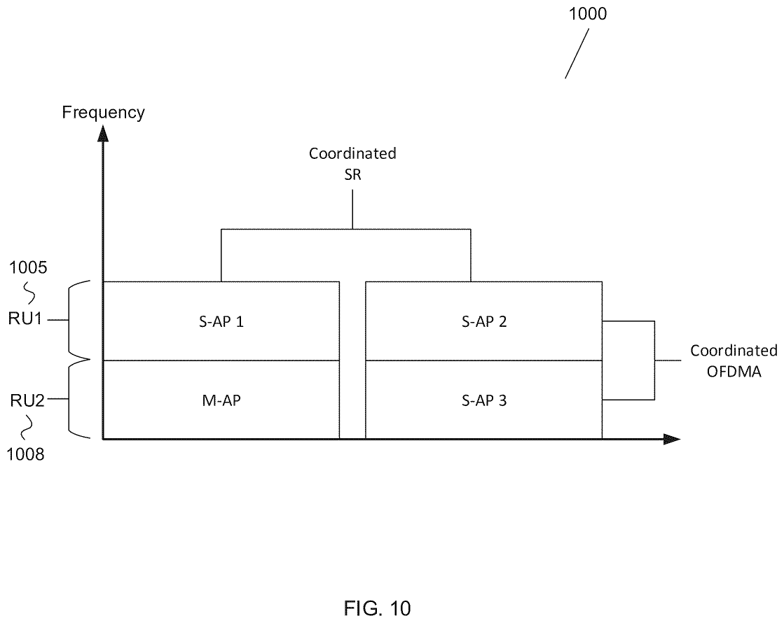

FIG. 8 illustrates an example where the present disclosure is deployed within a cluster, and the spatial domain is the chosen domain of co-existence, according to an embodiment. Notably in FIG. 8, FIG. 9 (described below) and FIG. 10 (described below) which visualize the coordination strategy, the axis represents Frequency Domain. As illustrated in FIG. 8, if both APs (e.g., M-AP 803 and S-AP 804) share the same bandwidth (e.g., Resource Unit 805), a strategy of spatial domain coordination is used. As illustrated in FIG. 9, if each AP (e.g., M-AP 903 and S-AP 904) is assigned a different RU (e.g., RU1 905 and RU2 908), a strategy of frequency domain coordination is used.

In FIG. 8, the M-AP 803 is configured to deploy co-existence in the spatial domain where the APs (including M-AP 803 and S-AP 804) share the same channel and transmit with TX powers that guarantee the minimum SIR across STAs (including STA 806 and STA 807). In other words, the M-AP 803 and the S-AP 804 are assigned an overlapping Resource Unit (RU) 805. In a scenario where each AP is associated with multiple STAs (such as in FIG. 6), M-AP 604 is configured to deploy co-existence in the spatial domain so that the minimum SIR across all STAs (e.g., STA 608, STA 609, STA 610, STA 611, STA 612 illustrated in FIG. 6) can be guaranteed. This corresponds to the CSR method as described herein.

FIG. 9 illustrates an example where the present disclosure is deployed within a cluster, and the frequency domain is the chosen domain of co-existence, according to an embodiment. This corresponds to the C-OFDMA method as described herein. M-AP 903 is configured to deploy co-existence in the frequency domain where M-AP 903 and S-AP 904 are assigned a non-overlapping RU divided as RU1 905 and RU2 908 respectively.

In addition, FIG. 10 illustrates an example where the present disclosure is deployed amongst multiple APs (two clusters), and the frequency and spatial domain are both deployed for co-existence, according to an embodiment. The overall four AP networks (e.g., M-AP, S-AP 1, S-AP 2, and S-AP 3) co-exist on the spatial and frequency domains simultaneously, where cluster 1 consists of S-AP 1 and S-AP 2 and cluster 2 consists of M-AP and S-AP 3.

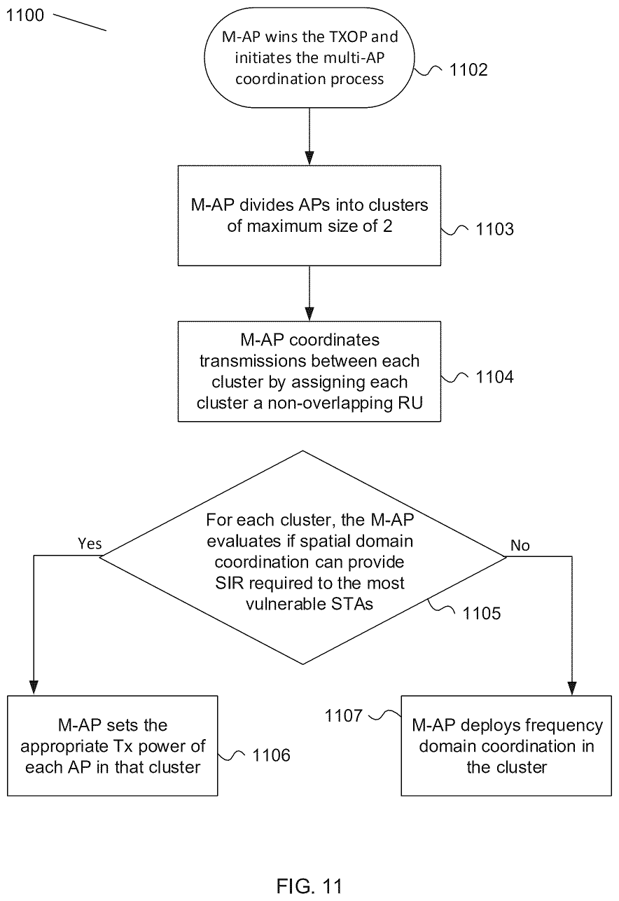

FIG. 11 illustrates a flowchart of an embodiment. Notably, FIG. 10 and FIG. 11 should be viewed together to better understand a hybrid scheme according to an embodiment.

Referring to FIG. 11, at step 1102, the M-AP wins the TXOP and initiates the multi-AP coordination process (as described aforementioned in the preparation phase). At step 1103, the M-AP divides APs into clusters of maximum size of 2 (thus decreasing the order of inter-BSS interference). Referring to FIG. 10, the M-AP and S-AP3 are grouped into one cluster, and the S-AP1 and S-AP2 are grouped into another cluster. In other words, the APs that interfere with each other the least are grouped together into a cluster.

At step 1104, the M-AP coordinates transmissions between each cluster by assigning each cluster a non-overlapping RU. Referring to FIG. 10, the cluster of S-AP1 and S-AP2 is assigned RU1 1005, and the cluster of M-AP and S-AP3 is assigned RU2 1008. As a result, these two clusters coordinate their transmissions using frequency domain coordination.

Subsequently, the M-AP looks within each cluster and selects the domain that is suitable for coordination, and it is also assumed that the APs within each cluster are far enough for spatial domain coordination to be suitable. For each cluster, the M-AP evaluates if spatial domain coordination can provide SIR required to the most vulnerable STAs. If the answer is yes, at step 1106, the M-AP sets the appropriate TX power of each AP in that cluster. If the answer is no, at step 1107, the M-AP deploys frequency domain coordination in the cluster.

Thus, there are two levels of coordination: the inter-cluster coordination and the intra-cluster coordination. With inter-cluster coordination (i.e., coordination between different clusters), frequency domain coordination is used, meanwhile, with intra-cluster coordination (i.e., coordination within each cluster), either frequency domain coordination or spatial domain coordination can be used.

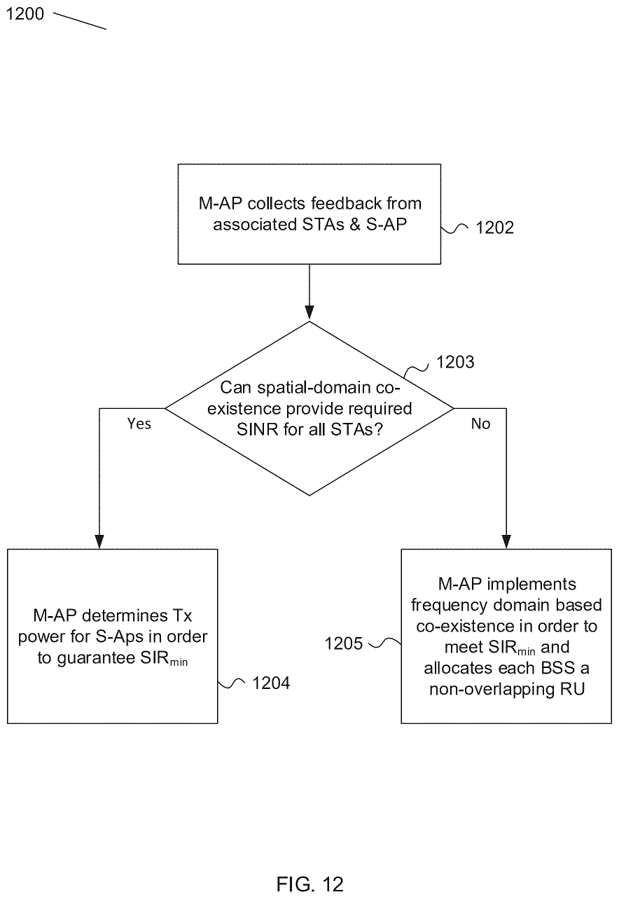

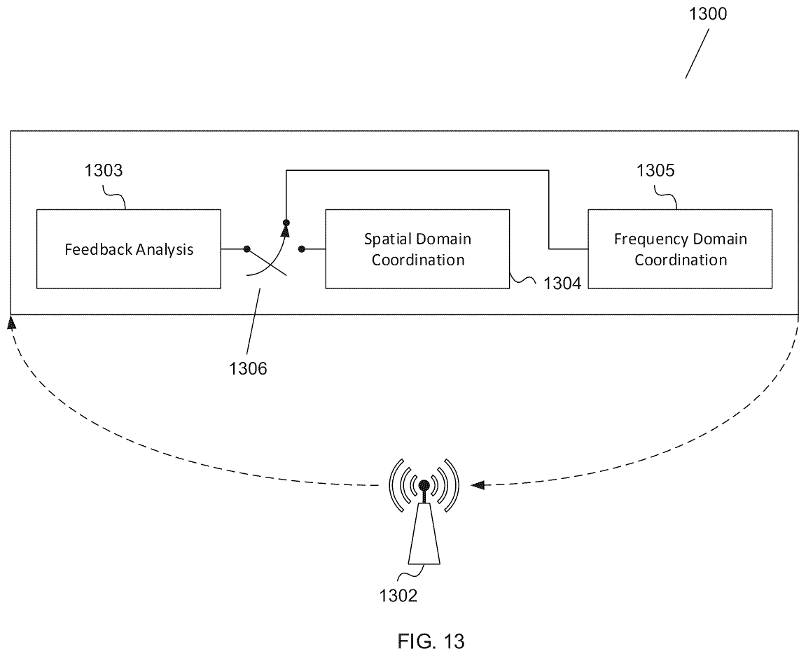

FIG. 12 illustrates a flowchart of an embodiment that may be used within a cluster. At step 1202, M-AP collects feedback from associated STAs and S-AP (e.g., as part of feedback analysis 1303 in FIG. 13). At step 1203, it is determined that whether spatial domain co-existence can provide a required Signal-to-Interference Ratio (SIR) for all STAs. If the answer is yes, at step 1204, M-AP determines TX power for S-APs in order to guarantee SIRₘᵢₙ. If the answer is no, at step 1205, M-AP implements frequency domain-based co-existence in order to meet SIRₘᵢₙ and allocate each BSS a non-overlapping RU.

FIG. 13 further illustrates the feedback process of intra-cluster coordination architecture, according to an embodiment. At step 1303, S-AP 1302 is configured to provide feedback to the M-AP, facilitating the exchange of interference and path loss information between the APs. Based on feedback analysis 1303, the M-AP determines at step 1306 whether spatial domain coordination 1304 or frequency domain coordination 1305 should be used.

As mentioned above, FIG. 14 presents a process for exchanging Coordinated Shared Resource (CSR) frames, according to an embodiment. In simple terms, a M-AP measures an acceptable level of interference at its Stations (STAs) to keep a certain minimum Signal-to-Interference Ratio (SIR). It then determines the highest transmission power of a secondary AP (S-AP) that will not result in interference surpassing this acceptable level at its STAs. The M-AP communicates at full power and sends this data to the S-AP in a trigger frame to kick off the CSR transmission. FIG. 14 also shows multiple shared APs, like AP 1407 and AP 1408, and various STAs, such as STA A 1409 and STA B 1410, participating in four phases of the CSR process: the preparation phase 1402, the setup and clustering phase 1403, the trigger phase 1404, and the data and acknowledgment phase 1405.

Referring to FIG. 14, the preparation phase 1402 occurs before any AP wins the TXOP and initiates multi-AP coordination. The main goal of this preparation phase 1402 is to provide each AP with the necessary information for the upcoming phase. At the preparation phase 1402, each AP broadcasts its multi-AP coordination capabilities via broadcast frames (in other words, each AP collects multi-AP coordination capabilities of neighboring AP). As a result, each AP will be aware of neighboring APs which support multi-AP coordination. Thus, by listening to the on-going transmission of beacon frames, each AP keeps a list of neighboring APs which support multi-AP coordination. In embodiments, this information is broadcasted via the APs in broadcast frames such as the beacon frame. For example, referring to FIG. 14, AP 1407 and AP 1408 broadcast their multi-AP coordination capabilities at step 1411.

In addition, each AP triggers its associated STAs to measure path loss from itself and from each neighboring AP. At the preparation phase 1402, each AP collects path loss reports from its associated STAs, which indicate the path loss values from each neighboring AP to each one of the STAs. As a result, each AP constructs a table to keep track of neighboring APs in terms of their multi-AP coordination capabilities and the path loss values of its associated STAs. For example, referring to FIG. 14, AP 1407 and AP 1408 request path loss report from STA A 1409 and STA B 1410 respectively at step 1412, and STA A 1409 and STA B 1410 perform measurement and send back the path loss reports to AP 1407 and AP 1408 respectively at step 1413.

In other words, at step 1413, measurement result request and response are transmitted from AP 1407 to STA A 1409 and vice versa; similarly, measurement result request and response are transmitted from AP 1408 to STA B 1410, and vice versa.

The setup phase 1403 begins when the M-AP is willing to initiate multi-AP coordination. The goal of this setup phase 1403 is for the M-AP to cluster multiple APs into clusters, which in embodiments may be a maximum size of 2, further determine the domain of coordination with each cluster, and specify transmission parameters. In embodiments, the setup process begins by the M-AP requesting path loss values from the neighboring S-APs. The S-APs report the path values of the STAs most susceptible to interference from each AP. Using the reported information, the M-AP is able to cluster APs in order to reduce the complexity of coordination as mentioned earlier. Subsequently, each cluster is treated as an independent multi-AP network, which is easier to manage due to the smaller number of APs.

Afterward, the goal is to set up the intra-cluster, multi-AP transmission such that the objective is achieved which guarantees a minimum required SIR across each STA within each cluster. For example, considering a cluster consisting of the M-AP and an S-AP where STAm is associated to the M-AP and STA k is associated to the S-AP, this goal (of setting up the intra-cluster, multi-AP transmission which guarantees a minimum required SIR across each STA within each cluster) for STA m and STA k which can be expressed as follows:

$$S I {R}_{m} = ( {P}_{M} - {P}_{L , m} ) - ( {P}_{S} - {P}_{L , m}^{′} ) \qquad ( A 1 )$$

$${P}_{M} - {P}_{S} \geq S I {R}_{min} + {P}_{L , m} - {P}_{L , m}^{′} \qquad ( A 2 )$$

$$S I {R}_{k} = ( {P}_{S} - {P}_{L , k} ) - ( {P}_{M} - {P}_{L , k}^{′} ) \qquad ( B 1 )$$

$${P}_{S} - {P}_{M} \geq S I {R}_{min} + {P}_{L , k} - {P}_{L , k}^{′} \qquad ( B 2 )$$

Accordingly, the M-AP decides which domain is more suitable for intra-cluster coordination to achieve the design goal. Firstly, the M-AP evaluates the spatial domain because this would allow each AP to utilize the whole channel bandwidth leading to higher throughputs, unlike frequency domain coordination where the channel is divided amongst multiple APs/BSSs. The SIR across most susceptible STAs is expressed in terms of TX powers of each AP and path loss values as seen in equations (A2) and (B2).

Upon combining both inequalities accordingly, the following inequality is obtained:

$$S I {R}_{min} - {P}_{L , m}^{′} + {P}_{L , m} \leq {P}_{M} - {P}_{S} \leq {P}_{L , k}^{′} - {P}_{L , k} - S I {R}_{min} \qquad ( C )$$

As seen, inequality (C) is the mathematical representation of the goal of providing the minimum required SIR for both STAs. Equation (C) is used to assess the usability of the spatial domain for co-existence as it states the range of differences between TX powers of the M-AP and S-AP which guarantees the minimum required SIR among each STA in the network. In other words, the solution of (3) provides the appropriate TX power value of each AP in order to achieve the design goal. On the other hand, if the inequality has no solutions, then spatial domain-based co-existence is not sufficient to achieve objective (2). In such cases, the M-AP resorts to coordination in the frequency domain by dividing the RU assigned to the cluster between both APs where transmissions can occur without TX power limitations thus providing the minimum required SIR.

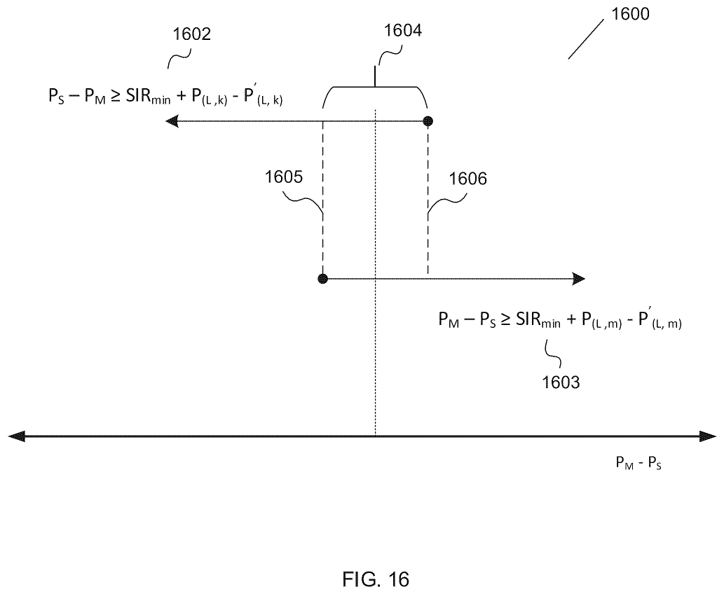

In the case where the spatial domain is selected for coordination, the transmission power of each AP is derived from the inequality (C) and the LHS and RHS of (C) are the boundaries for acceptable difference between transmission power of the M-AP and the S-AP. Despite the fact that any value within these boundaries would achieve the objective, the midpoint of the boundaries is selected in order to add immunity to noise and errors in pathloss estimations by the STAs. This can be seen clearly in FIG. 16 where the LHS and RHS conditions of (C) are represented and the solution is the overlapping region highlighted. Even though any value within the overlapping region is a solution to the research problem, selecting the midpoint, represented by the red dashed line, of this region adds the most immunity to error and noise as mentioned earlier. On the other hand, if the frequency domain is selected for coordination, then the channel is divided between each BSS equally between APs.

Lastly, the transmission phase (1404 and 1405) begins by the M-AP sending a trigger frame to the selected S-APs which includes TX power limitations when co-existence is achieved in the spatial domain or RU assignment when co-existence is achieved in the frequency domain. Upon reception of the trigger frame, each S-AP begins transmission according to the parameters specified in the trigger frame. In embodiments for CSR trigger 1404, CSR trigger can be set up at AP 1407 first and then AP 1408 responds back if the channel is idle.

In embodiments for CSR data 1405, CSR data (e.g., data frames) from AP 1407 can be sent to and received by STA A 1409; similarly, CSR data from AP 1408 can be sent to and received by STA B 1410. In embodiments, Block Acknowledgement (BA) frames from STA A 1409 can be sent to and received by AP 1407 and similarly, BA frames from STA B 1410 can be sent to and received by at AP 1408. In other words, the APs are sending data frames (represented by solid rectangles “CSR data” in FIG. 14), and the STAs are receiving them (represented by dashed rectangle “CSR data”). Likewise, the STAs are sending BA frames (represented by solid rectangles “BA” in FIG. 14), and the APs are receiving them (represented by dashed rectangles “BA”).

In embodiments, TXOP 1406 is across the CSR setup 1403, CSR trigger 1404 and CSR data and acknowledgement 1405.

Despite the improvement and performance gains shown by CSR, one of its main weaknesses is that it suffers tremendously in dense deployments with high inter-BSS interference. This is due to the spatial proximity of neighboring APs in dense deployments. In such cases, the S-AP's STAs tend to experience a very low SIR due to interference from the close-by M-AP leading to degraded performance. In addition, due to the M-AP only attempting to achieve coordination in the spatial domain, the multi-AP network may have no choice but to tolerate the co-channel interference due to the close proximity of neighboring BSSs to one another. Furthermore, the APs lack the ability to simultaneously consider alternative domains for coordination and lack the situational awareness to select the most suitable one based on the given inter-BSS interference conditions. As a result, CSR fails to provide the required communication performance effectively and reliably in dynamic, ultra-dense conditions. The effect of such design is evident when considering OBSS STAs associated to an S-AP suffering from low SIR due to limitations of spatial-domain-based coordination whereas frequency-domain-based coordination could be a better alternative for coordination thus providing a higher SIR and MCS index.

On the other hand, unlike CSR, C-OFDMA provides a much better performance in deployments with medium to high inter-BSS interference. Despite such improvements, C-OFDMA may degrade overall system performance in ultra-dense deployments. This is due to how C-OFDMA achieves coordination where the channel is divided into RUs among the BSSs in the multi-AP network. Consequently, a high number of BSSs in a multi-AP network or a channel which is not wide enough would lead to performance degradation where some BSSs would not be assigned a RU due to the coordinating AP running out of unassigned RUs. Furthermore, existing CSR schemes' design does not support multiple S-AP networks. This is due to the increasing complexity with additional APs in ultra-dense deployments. In addition, CSR does not aim to ensure that the S-AP's STAs' do not experience beyond tolerable interference, unlike M-AP STAs. This is due to CSR always ensuring that the M-AP transmits at the maximum power and the S-AP always reducing their TX power. Such a rigid, inflexible design degrades the overall network performance in scenarios where the S-AP transmitting at full power instead of the M-AP yields to a better net performance due to more S-AP STAs being susceptible to inter-BSS STAS.

Drawing from the limitations of CSR and C-OFDMA, a need has emerged for a multi-AP coordination scheme that goes beyond these frameworks. First, a multi-dimensional coordination approach is crucial, allowing the incorporation of various domains to guarantee a minimum SIR across all STAs, thus overcoming the low SIR issues arising from spatial proximity in dense deployments as experienced in CSR. Second, situational awareness should be a key feature of the scheme. It should take into account the unique deployment scenario and inter-BSS interference when strategizing coordination and adjusting transmission parameters, which could help overcome the problems observed in ultra-dense deployments with CSR and C-OFDMA.

Finally, the proposed scheme should provide multi-AP support, capable of accommodating any arbitrary number “n” of APs. This functionality addresses a major shortcoming of CSR, which has difficulty supporting multiple S-AP networks due to escalating complexities with additional APs in ultra-dense deployments. Furthermore, it should also aim to ensure that S-AP's STAs do not experience beyond tolerable interference, countering CSR's rigid design that contributes to degraded network performance in certain scenarios.

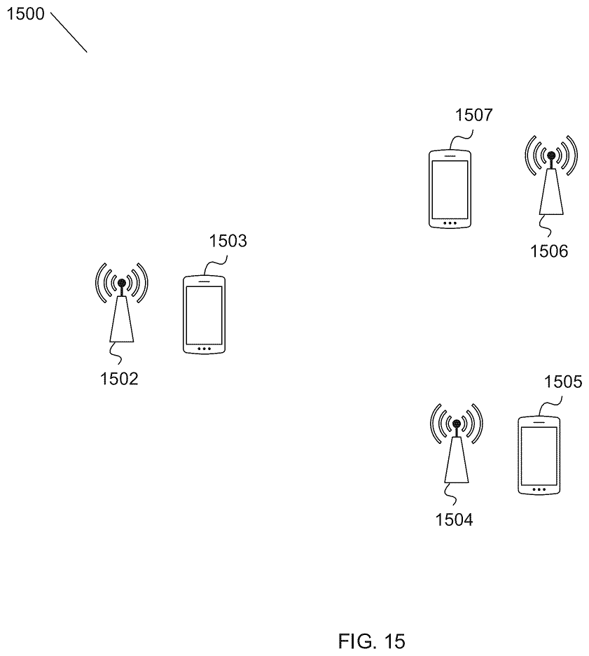

Therefore, FIG. 15 illustrates a scenario including three APs (e.g., AP 1 as 1502, AP 2 as 1504 and AP 3 as 1506) and three STAs (e.g., STA 1 as 1503, STA 2 as 1505 and STA 3 as 1507). The SIR of STA 1 as 1503 can be formulated in terms of the transmission powers of each AP and the pathloss values as:

$$S I R = \frac{1 {0}^{\frac{{P}_{AP 1} - {P}_{L 1}}{10}}}{1 {0}^{\frac{{P}_{AP 2} - {P}_{L 2}}{10}} + 1 {0}^{\frac{{P}_{AP 3} - {P}_{L 3}}{10}}} \qquad ( 1 )$$

As described herein, the APs are grouped into clusters of a maximum size of 2, which is done in order to decrease the complexity by reducing the number of variables. Each cluster is assigned a non-overlapping RU, allowing these clusters to co-exist in the Frequency domain. Each cluster is considered as its own multi-AP network.

Before clustering, in order to guarantee a minimum required SIR for each STA, this can be expressed for STA 1 as 1503 as follows:

$$\frac{1 {0}^{\frac{{P}_{AP 1} - {P}_{L 1}}{10}}}{1 {0}^{\frac{{P}_{AP 2} - {P}_{L 2}}{10}} + 1 {0}^{\frac{{P}_{AP 3} - {P}_{L 3}}{10}}} \geq S I {R}_{min} \qquad ( 2 )$$

Upon mathematical manipulation, the following is obtained:

$$\frac{1 {0}^{\frac{{P}_{AP 1}}{10}}}{1 {0}^{\frac{{P}_{L 1}}{10}}} \geq 1 {0}^{\frac{{SIR}_{min , dB}}{10}} ( 1 {0}^{\frac{{P}_{AP 2} - {P}_{L 2}}{10}} + 1 {0}^{\frac{{P}_{AP 3} - {P}_{L 3}}{10}} ) \qquad ( 3 )$$

Upon expanding in terms of an arbitrary number of “n” APs:

$$\frac{1 {0}^{\frac{{P}_{AP 1}}{10}}}{1 {0}^{\frac{{P}_{L 1}}{10}}} \geq 1 {0}^{\frac{{SIR}_{min , dB}}{10}} ( 1 {0}^{\frac{{P}_{AP 2} - {P}_{L 2}}{10}} + ... + {10}^{\frac{{P}_{A P n} - {P}_{L n}}{10}} ) \qquad ( 4 )$$

The above equations (1) to (4) are difficult to solve for a large number of APs. As seen in formula (4), the complexity of solving for the TX power for each AP which achieves objective (2) increases, as the number of APs in the network increases. Embodiments reduce the complexity of the problem via implementing a cluster-based approach which aims to divide the multi-AP network into clusters where each one is treated as an independent multi-AP network and is assigned a non-overlapping RU. Afterward, for each cluster, the M-AP selects the domain of coordination for intra-cluster, multi-AP coordination. Finally, the M-AP specifies the appropriate TX parameters.

Referring to FIG. 15, after clustering (assuming AP1 1502 and AP2 1504 are clustered together), the formula (4) is simplified as below:

$$( {P}_{AP 1} - {P}_{L 1 , 1} ) - ( {P}_{AP 2} - {P}_{L 1 , 2}^{′} ) \geq S I {R}_{min}$$

As mentioned above, referring to formula (B1), the SIR for STA k can be expressed as

$$S I {R}_{k} = ( {P}_{S} - {P}_{L , k} ) - ( {P}_{M} - {P}_{L , k}^{′} )$$

where the TX power of the M-AP and the S-AP are denoted by P_{M} and P_{S} respectively. STA k requires a minimum SIR denoted by SIRₘᵢₙ to achieve a required data rate. The objective is to guarantee that SIRₖ would be equal or higher than SIRₘᵢₙ. As such, as mentioned above, the condition of (A2) and (B2) must be satisfied, which yields the (C) which is a mathematical expression of the range of values which (P_{M}-P_{S}) must be within in order for spatial domain coordination to satisfy the research objective. If the left-hand-side (LHS) of (C) which is denoted as

$$S I {R}_{min} - {P}_{L , m}^{′} + {P}_{L , m}$$

(referred to as 1603 in FIG. 16)>the right-hand-side (RHS) of (C) which is denoted as

$${P}_{L , k}^{′} - {P}_{L , k} - S I {R}_{min}$$

(referred to as 1602 in FIG. 16 reversely), then there is no possible solution. In other words, spatial domain coordination cannot achieve the objective of guarantee that SIRₖ would be equal or higher than SIRₘᵢₙ. Thus, frequency domain coordination would be the only choice for intra-cluster coordination since no values of P_{M} or P_{S} can solve the aforementioned equation (C):

$$S I {R}_{min} - {P}_{L , m}^{′} + {P}_{L , m} \leq {P}_{M} - {P}_{S} \leq {P}_{L , k}^{′} - {P}_{L , k} - S I {R}_{min} \qquad ( C )$$

FIG. 16 illustrates a process of intra-cluster coordination, where the two solid lines together with two dotted lines 1605 and 1606 represent the region of solutions, and the dotted line 1604 represents the midpoint 1604 taken as the solution, according to an embodiment. Notably, FIG. 16 should be viewed together with the above formula (C).

Referring to formula (C), if LHS>RHS, the M-AP selects the frequency domain coordination, thus according to embodiments, the channel is divided equally between BSSs and each AP transmits at maximum power since inter-BSS interference is completely avoided.

In embodiments, the M-AP may select spatial domain coordination. In an embodiment, the executable program code can be expressed as follows, where

$$average = \frac{( L H S + R H S )}{2} :$$

```
if Spatial domain is selected then
  Each BSS is assigned the entire channel
  if average of LHS and RHS ≥ 0 then
    Transmission power of M-AP = 21 dBm
    Transmission power of S-AP = 21 − average
  end if
  if average of LHS and RHS < 0 then
    Transmission power of S-AP = 21 dBm
    Transmission power of M-AP = 21 + average
  end if
end if
if Frequency domain is selected then
  Each AP transmits at maximum power
  Channel is divided equally between both BSSs in
  multiples of 20 MHz RU.
Any remainder is assigned to the M-AP.
End if
```

Where the values of 21 dBm (or simply 21), and 20 MHz correspond to one embodiment. Other embodiments may use different values appropriate to their application.

Despite any value of (P_{M}−P_{S}) within the boundaries of (C) being a valid solution, the mid-point of the boundaries may be taken in order to add immunity to errors in pathloss estimations or abrupt changes in interference conditions over a short interval of time since the midpoint is the point which is the furthest from both boundaries.

In summary, the present disclosure provides a cluster-based, integrated multi-dimensional multi-AP coordination scheme (hybrid), which is proposed for multi-AP networks with more than two APs. In order to reduce the additional complexity due to the increase in number of APs, the proposed scheme is configured to cluster the multiple APs into clusters of a maximum size of 2. Each cluster is assigned a non-overlapping RU, allowing these clusters to co-exist in the frequency domain. Each cluster is considered as an independent multi-AP network.

Notably, within each cluster, the SIR of the STAs most susceptible to inter-BSS interference may be formulated in terms of the TX powers of each AP within the cluster and the corresponding path loss values. The M-AP solves for TX power value which would guarantee the required SIR for those STAs and sets the TX power of each AP accordingly (referred to as “Spatial Coordination”). Furthermore, if a solution is not possible, the M-AP divides the allocated RU equally between these BSSs (referred to as “Frequency Domain Coordination”)

As a result, inter-cluster transmissions are coordinated via Frequency domain coordination and intra-cluster transmissions are coordinated via the Spatial domain when appropriate or the Frequency domain when not.

As such, the technical advantages or benefits of the proposed scheme can be summarized as follows:

First, the situation aware, multi-dimensional design of the proposed scheme allows the leading AP to evaluate the inter-BSS interference conditions, develop both frequency and spatial domain coordination schemes, and specify the appropriate corresponding transmission parameters. As a result, the multi-AP network does not have to tolerate the limitations of a specific domain and, as a result, can offer higher degrees of reliability compared to existing CSR and C-OFDMA schemes.

Second, the proposed cluster-based scheme supports multi-AP coordination in ultra-dense deployments unlike existing CSR and C-OFDMA schemes which support a limited number of APs.

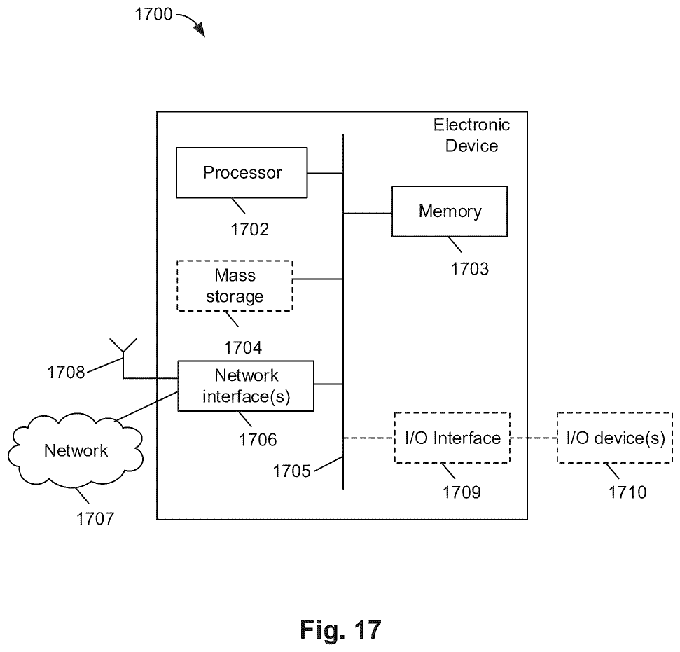

FIG. 17 illustrates an apparatus such as an electronic device 1700, according to an embodiment, that may perform any or all of operations of the methods and features explicitly or implicitly described herein, according to one or more aspects of the disclosure.

As shown, the apparatus 1700 may include a processor 1702, such as a Central Processing Unit (CPU) or specialized processors such as a Graphics Processing Unit (GPU) or other such processor unit, memory 1703, non-transitory mass storage 1704, input-output (I/O) interface 1709, and network interface(s) 1706, all of which are communicatively coupled via bi-directional bus 1705. I/O interface 1709 may be connected to various I/O devices(s) 1710 as required by each configuration of electronic device 1700. Similarly, network interface(s) 1706 may interface to various network, for example network 1707.

According to certain aspects, any or all of the depicted elements may be utilized, or only a subset of the elements. Further, electronic service 1700 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

Memory 1703 may include any type of non-transitory memory such as static random-access memory (SRAM), dynamic random-access memory (DRAM), synchronous DRAM (SDRAM), read-only memory (ROM), any combination of such, or the like. The mass storage element 1704 may include any type of non-transitory storage device, such as a solid-state drive, hard disk drive, a magnetic disk drive, an optical disk drive, USB drive, or any computer program product configured to store data and machine executable program code. According to certain aspects, memory 1703 or mass storage 1704 may have recorded thereon statements and instructions executable by the processor 1702 for performing any of the aforementioned method operations described above.

Embodiments of the present disclosure can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

Actions associated with methods described herein can be implemented as coded instructions in a computer program product. In other words, the computer program product is a computer-readable medium upon which software code or instructions is recorded to execute the method when the computer program product is loaded into memory and executed on a processor of a computing device.

Further, each operation of the method may be executed on any real or virtual computing device, such as a personal computer, server, tablet, smartphone, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A method for initiating multiple Access Point (multi-AP) communications in a wireless network, the method comprising:
broadcasting, by an access point (AP), a broadcast frame indicating a multi-AP coordination capability;
sending, by the AP to a station (STA) associated with the AP, a trigger for a path loss report;
receiving, by the AP from the STA associated with the AP, the path loss report;
receiving, by the AP from a second AP, an indication of a second multi-AP capability of the second AP, the AP adding the second AP to a list of multi-AP capable APs of the wireless network; and
winning, by the AP, a transmission opportunity (TXOP) of a channel of the wireless network.

2. The method of claim 1, wherein the broadcast frame is a beacon frame.

3. The method of claim 1, wherein the AP receives a second broadcast frame indicating the second multi-AP capability.

4. The method of claim 3, wherein the second broadcast frame is a second beacon frame.

5. A method for organizing multiple Access Point (multi-AP) communications in a wireless network, the method comprising:
determining, by a main access point (M-AP), a first path loss between a first station (STA) and the M-AP;
sending, by the M-AP to a secondary access point (S-AP), a request for a path loss report of a second STA associated with the S-AP;
receiving, by the M-AP, the path loss report;
grouping, by the M-AP, at most two access points (APs) into a cluster, the at most two APs having a multi-AP capability, a first AP of the cluster being the M-AP, a second AP of the cluster being the S-AP;
evaluating, by the M-AP, a spatial configuration of the M-AP and the S-AP;
adjusting a first transmit power level of the M-AP; and
adjusting a second transmit power level of the S-AP, the first transmit power level and the second transmit power level guaranteeing a minimum required signal to interference ratio (SIR) for the first STA and the second STA.

6. The method of claim 5, wherein the adjusting the first transmit power level and the adjusting the second transmit power level includes adjusting a transmit power of the M-AP or adjusting a transmit power of the S-AP so that an SIR of the first STA or the second STA exceeds the minimum required SIR.

7. The method of claim 5, further comprising:
allocating, by the M-AP, a first non-overlapping portion of a channel of the wireless network to the M-AP and a second non-overlapping portion of the channel to the S-AP.

8. The method of claim 5, wherein the at most two APs of the cluster are determined based on the path loss report.

9. The method of claim 5, wherein the first STA is one of a plurality of STAs most susceptible to interference from a third AP of the wireless network.

10. The method of claim 9, wherein the third AP is one of the M-AP or the S-AP.

11. The method of claim 5, wherein the cluster includes one or two multi-AP capable access points.

12. An apparatus for initiating multiple Access Point (multi-AP) communications in a wireless network, the apparatus comprising:
at least one processor; and
a non-transitory computer readable memory storing instructions, that when executed by the at least one processor, cause the apparatus to perform:
broadcasting a broadcast frame indicating a multi-AP coordination capability, wherein the apparatus is or is part of an access point (AP);
sending, to a station (STA) associated with the AP, a trigger for a path loss report;
receiving, from the STA associated with the AP, the path loss report;
receiving, from a second AP, an indication of a second multi-AP capability of the second AP, the AP adding the second AP to a list of multi-AP capable APs of the wireless network; and
winning a transmission opportunity (TXOP) of a channel of the wireless network.

13. The apparatus of claim 12, wherein the broadcast frame is a beacon frame.

14. The apparatus of claim 12, wherein the AP receives a second broadcast frame indicating the second multi-AP capability.

15. The apparatus of claim 14, wherein the second broadcast frame is a second beacon frame.
